(19) United States
(12) Patent Application Publication
(10) Pub. No.: US 2020/0369461 A1
(43) Pub. Date: Nov. 26, 2020

(54) BEVERAGE POWDER- AND FILLER-CONTAINING CAPSULE, IN PARTICULAR FOR PREPARING BREWED COFFEE

(71) Applicant: SWISS COFFEE INNOVATION AG, Olten (CH)

(72) Inventor: Axel NICKEL, Hemmingen (DE)

(73) Assignee: SWISS COFFEE INNOVATION AG, Olten (CH)

(21) Appl. No.: 16/961,325

(22) PCT Filed: Jan. 14, 2019
(86) PCT No.: PCT/EP2019/050827

§ 371 Date: Jul. 10, 2020

(30) Foreign Application Priority Data
Jan. 15, 2018 (EP) 18151614.7

(51) Int. Cl. B65D 85/804; B65D 65/46; A23F 3/32; A23F 5/12; A23F 5/14; A23F 5/38; A23P 10/28

(52) U.S. Cl. CPC B65D 85/8043; B65D 65/466; A23F 3/32; A23P 10/28; A23F 5/14; A23F 5/385; A23F 5/125

(57) ABSTRACT

A capsule for the preparation of a beverage from beverage powder, in particular of coffee from ground coffee, by introduction of water into the capsule comprises a pellet composed of a powder mixture, wherein the pellet is sheathed with at least one coating layer comprising a crosslinked polysaccharide, wherein the powder mixture of the pellet contains i) a polysaccharide-comprising powder having a first average particle size A and ii) a) a polysaccharide-comprising powder having a second average particle size B different from the first average particle size A and/or b) a filler having an average particle size C different from the first average particle size A or identical to the first average particle size A.

The present invention relates to a beverage powder-containing capsule which is particularly suitable for the preparation of a beverage, such as cocoa, tea, or coffee. In addition, the present invention relates to a method for adjusting the flow resistance of such a capsule, a method for producing such a capsule, and the use of such a capsule.

In the portion-wise preparation of beverages, in particular brewed coffee, coffee capsules have increasingly been used in addition to coffee pods, wherein the capsule walls of said coffee capsules are usually made of stainless steel, aluminum, or plastics material. Such capsules allow ground coffee to be stored for a longer period of time without loss of flavor. In addition, such capsules allow a quick and user-friendly production of a coffee portion with the desired taste by inserting a capsule with the desired type of coffee into an adapted coffee machine, in which hot water is then pressed through the capsule and brewed coffee is produced therefrom. However, capsules of this type are comparatively expensive, inter alia, owing to the capsule material used and the capsule construction which is expensive to produce. Furthermore, such capsules are problematic from an environmental point of view. First, the capsules are not recyclable and are usually disposed of as residual waste by the consumer after use. Recycling of coffee capsules therefore practically does not take place, which is of particular concern with aluminum-based coffee capsules, since aluminum production is very energy-intensive, which means that such capsules have a particularly poor CO₂ balance.

Another major disadvantage is that such capsules are not biodegradable and therefore cannot be disposed of biologically. In view of the fact that well over 4 billion coffee capsules are consumed in Germany alone and over 48 billion coffee capsules worldwide, this is a serious problem.

In order to at least partially avoid the above problems, capsules made of alternative materials have already been proposed.

A capsule is known from DE 10 2014 000 187 A1, which consists of a pellet made of a cellulosic powder, such as, in particular, ground coffee, wherein the pellet is sheathed with a layer composed of a biodegradable material. The sheathing layer is preferably a liquid cellulose which consists of a polysaccharide or a derivative thereof in combination with a polyol spacer and the associated crosslinker.

3 115 316 A1 discloses a capsule, in particular for preparing a beverage made from beverage powder, in particular coffee made from ground coffee, by the introduction of water into the capsule, wherein the capsule comprises a pellet made from a powder containing at least one polysaccharide, wherein the pellet is sheathed with at least one coating layer, wherein the at least one coating layer comprises a crosslinked polysaccharide, wherein the crosslinked polysaccharide is obtained by crosslinking a polysaccharide with a crosslinking agent without using a polyol spacer.

These capsules are biodegradable and therefore environmentally friendly. However, it is difficult with these capsules to set the flow resistance and thus the extraction properties with hot water to a desired value. In order to process the capsules described above with a fully automatic coffee machine adapted to them for ready-to-drink coffee, these capsules must have a standardized size. In addition, these should have a defined flow resistance so that the coffee can be extracted from the capsules in the fully automatic coffee machine using the same water pressure in the same time. For example, the extraction time should not exceed 25 s at a water pressure of 9 bar. However, the flow resistance of such capsules depends on a number of different factors, in particular on the degree of grinding, the compressing pressure with which the capsules were produced, and other factors. The finer the degree of grinding of the powder, the lower the porosity of the capsule made from it, since fewer cavities remain between smaller particles than between larger particles. Different types of coffee, however, also require a different degree of grinding in order to produce coffee with an excellent taste. Espresso, for example, is more fine-grained than filter coffee. For this reason, it is difficult to process the capsules described above, regardless of the type of coffee, using a fully automatic coffee machine and to process coffee with a defined coffee concentration.

Proceeding from this, the present invention has for its object to provide a capsule for the portion-wise preparation of beverages made from beverage powder, such as cocoa, tea, and coffee, which is not only easy and inexpensive to manufacture, biodegradable, and therefore environmentally friendly to dispose of, and also can store the capsule contents over a longer period of time without any noteworthy loss of flavor, but which in particular can be easily adjusted to a defined flow resistance which is constant during the extraction process.

According to the invention, this object is achieved by a capsule for the preparation of a beverage made from beverage powder, in particular of coffee made from ground coffee, by introduction of water into the capsule, wherein the capsule comprises a pellet composed of a powder mixture and the pellet is sheathed with at least one coating layer comprising a crosslinked polysaccharide, wherein the powder mixture of the pellet contains i) a polysaccharide-comprising powder having a first average particle size A and ii) a) a polysaccharide-comprising powder having a second average particle size B different from the first average particle size A and/or b) a filler, preferably an inert filler, having an average particle size C different from the first average particle size A or identical to the first average particle size A.

This solution is based on the knowledge that by mixing into a powder mixture containing a polysaccharide-comprising powder having a first average particle size A of a suitable amount of a polysaccharide-comprising powder having a suitable second average particle size B different from the first average particle size A and/or a filler, preferably an inert filler, having a suitable average particle size C different from the first average particle size A or having the first average particle size A and by subsequently compressing the powder mixture using a suitable compressing pressure, the flow properties of the pellet can be adjusted such that the capsule produced therefrom has a selectable, defined, and constant flow resistance during the extraction, regardless of the type and degree of grinding of the polysaccharide used, in particular regardless of the type of coffee used and the degree of grinding of the coffee. For this reason, the capsules according to the invention can be processed with a fully automatic coffee machine into ready-to-drink coffee with excellent and consistent quality, regardless of the type of coffee and the degree of coffee ground, since the extraction time of the capsules according to the invention is the same for hot water regardless of the type of coffee and the degree of grinding of the coffee. Consequently, the capsules according to the invention are also particularly suitable for ground coffee having a fine or even very fine degree of grinding, which, due to its large surface area, produces a good extraction, but because of the small capillaries between the fine powder grains without admixing the second component ii) would have an excessively high flow resistance. The admixture of the second component ii) thus introduces a degree of freedom for the formulation of the powder mixture, which leads to an at least partial decoupling of the other parameters which are otherwise dependent on one another, namely the degree of grinding, density, weight of the pellet, volume of the pellet and type of coffee. Since the capsules according to the invention consist of a pellet sheathed with at least one coating layer comprising a crosslinked polysaccharide, the capsules can also be disposed of in an environmentally friendly manner. In particular, the at least one coating layer made of a crosslinked polysaccharide is stable enough to provide the capsule with a sufficiently high level of transport protection and touch protection. Apart from this, the capsule according to the invention also protects the capsule contents over a longer period of time without any appreciable loss of flavor occurring. By pressing the ground coffee into a pellet, the surface of the ground coffee, which is accessible to oxygen, is significantly reduced in comparison to non-compacted ground coffee. In addition, the capsule according to the invention is easy to produce in a spherical shape and is therefore ideally suited for use in a suitably adapted beverage machine, since it can roll.

According to the invention, the capsule according to the invention contains a pellet which is composed of a powder mixture, wherein the powder mixture of the pellet contains i) a polysaccharide-comprising powder, particularly preferably ground coffee, having a first average particle size A and ii) a) a polysaccharide-comprising powder, particularly preferably ground coffee, having a second average particle size B different from the first average particle size A and/or b) a filler, preferably an inert filler, having an average particle size C different from the first average particle size A or identical to the first average particle size A. It is particularly preferred that the powder mixture of the pellet in addition to the polysaccharide-comprising powder having the first average particle size A has a filler, preferably an inert filler, having an average particle size C different from the first average particle size A or identical to the first average particle size A.

For the purposes of the present invention, an inert filler is understood to mean a powdery material which is an approved food or an approved food additive and is preferably also storage-stable, odorless, and tasteless.

Particle size in the sense of the present invention is also understood to mean the average particle size and average particle size means the average particle size d₅₀, that is to say the value for the diameter which is below 50% of the particles present. A mixture of two particles having a different average particle size (i.e. having a different average particle size d₅₀) is therefore a mixture having a bimodal particle size distribution.

For a better description of the causal relationships, some mathematical-physical relationships are considered below.

In the case of extraction processes for hot beverages, such as for the espresso preparation, fluid, for example water, usually flows in a single-phased manner through a porous body, which can be, for example, a press cake made from ground coffee, under specified properties. This press cake is also known as a pile because it consists of a bed of particles. Such piles can be described exactly as long as they are composed of a bed of spherical particles. Descriptive parameters are the diameter d_{P}, the degree of gap and/or the porosity ε, and the capillary diameter d_{K}. For example, for the most compressed spherical packing, it results in a porosity of approx. 26% (Keppler's assumption). If the pile is composed of particles having different diameters or if they are not spheres, an exact description is no longer possible and either experimental data, statistical methods, or numerical simulation methods have to be used. The effective (external) porosity ε is calculated according to the formula

ε=(V_{S}−V_{P})/V_{S} (1),

where V_{S} represents the bulk volume and V_{P} the particle volume. The calculation from the bulk density and the particle density is only permissible as long as the particles have no internal, closed porosity.

The extraction processes considered here are single-phase flow processes through porous bodies, so that capillary forces play no role, which results in a simplification. Furthermore, the flow-through processes are of a rather slow nature, so that there is a laminar flow and thus the frictional forces and not the inertial forces determine the flow resistance. Therefore, the Darcy equation can be used, which was derived from empirical momentum balances based on experimental investigations on sand fillings through which water flows. It is:

−∂p/∂x=η/K*u₀ (2)

It describes the pressure drop ∂p over a porous body having the permeability K, through which a fluid flows in one dimension in the x direction with the dynamic viscosity η and the inflow velocity u₀. The inflow velocity u₀ can be expressed by the quotient of the volume flow Q and the cross-sectional area of the porous body. Integration over the thickness I of the porous body ultimately leads to a new form of the Darcy equation:

Q/A=K/η*Δp/I (3)

or rewritten to K:

K=Q/A*η*I/Δp (4)

This allows the permeability of a porous body to be determined. A derivation from the Hagen-Poiseuille law gives a further connection between permeability and pore, and/or capillary diameter d_{K}:

K=ε*d²_{K}/32 (5)

Here ε is again the porosity, which can be determined using the formula given above.

Since the capillary diameters in the body are difficult to determine, the capillary diameter must be replaced by the average particle diameter d_{P}. There is a variety of experimental work here, since an exact relationship can only be obtained with spherical fill. For real particles that have an irregular surface and also have different diameters as a fraction, there can only be metrological relationships. According to Ergun, good results are obtained for sand fillings using the equation

d_{P}=2.165*(1−ε)/ε*d_{K} (6).

Another characteristic variable is the permeability value derived from the permeability. It is shown here because there are values in the literature to describe the permeability of a porous body:

K_{F}=K*ρ_{F}/η_{F}*g (7)

Here pF is the density of the medium flowing through (water at 90° C. e.g. ρ_{F}=965 kg/m³), η_{F} is the dynamic viscosity of the medium (water at 90° C. e.g. η_{F}=3.14* 10⁻⁴ kg/m/s) and g=9.81 m/s² is the acceleration due to gravity.

It is known from the literature that a good espresso should be prepared in addition to the suitable coffee according to the following rules:
Amount of water: V=25 ml
Preparation time: t=25 s
Flow pressure: p=9 bar

The quotient V/t gives the volume flow Q. And the flow pressure p results in the differential pressure Δp=p−p_{U}=8 bar with the ambient pressure p_{U}. A target value for an optimal espresso can be calculated with:

Q/Δp=1.25* 10⁻¹² m⁴*s/kg (8)

An espresso barista achieves this optimum value by an appropriate degree of grinding of the coffee to a fine ground coffee and by tempering or pressing into the portafilter. The fine grinding also exposes a large part of the inner, closed pores of the coffee beans, which enables optimal extraction. Different portafilter are used for espresso machines. A portafilter having an average diameter of 50 mm was selected for the investigations within the scope of the present patent application, which results in a flow area of A=1,963 mm². With a usual amount of ground coffee of 7 g, the ground coffee cake is approx. L=6.6 mm thick after appropriate pressing. This results in an average density of the ground coffee cake of approx. ρ_{KK}=0.54 g/cm³. A density of approx. ρ_{KB,r}=1.20 g/cm³ is specified for the coffee beans in the raw state and approx. ρ_{KB,g}=0.5-0.6 g/cm³ in the roasted state. This is due to the loss of roasting, i.e. the evaporation of volatile components, and the increase in volume due to the formation of an internal, closed porosity. It is therefore difficult to state the external porosity with certainty because the density of the whole, roasted beans is in the same range as the density of the pressed ground coffee cake. Therefore, in the calculation, the variables, such as the permeability and the permeability value, were first calculated independently of the porous body. In this example, the following were obtained:

K=1.32*10⁻¹⁵ m² and

K_{F}=3.98*10⁻⁸ m/s

The value for K_{F} coincides very well with values from the literature for poorly permeable porous bodies.

Because, as described above, the external, open porosity cannot be determined theoretically, its value was adjusted in the calculation program so that realistic values result for the average particle size. Microscopic examinations show average particle sizes for ground coffee for espresso applications of approx. 0.3 mm. This then corresponds to a value of ε=1.4%. This low value for the porosity is due on the one hand to the broad particle size scatter and is also explainable because the ground coffee swells and the capillaries become blocked due to fine particles being washed out during the brewing process.

The experimental determination of the porosity, which also covers all the other side effects described, now provides all the information for a particular ground coffee body. The derivation can now be used to determine the interdependencies of the individual variables. For this purpose, equations (3), (5), and (6) are transformed according to the target value given in equation (8) and the following is obtained:

Q/Δp=2/3*10⁻²/η*A/I*ε³/(ε−1)²*d_{P}²

The target value for a good espresso is on the left. If this value is to be reached, there are now various options by influencing the variables on the right-hand side. On the right-hand side, the first terms are constant numerical values or constants, such as the dynamic viscosity of water η, and are thus fixed. The variables A and I can either be changed by the geometry of the porous body or by the admixture of an inert mixture partner using the same size distribution of the ground coffee. As a result, the values for the porosity and the particle diameter remain constant, but with the same proportion of active ingredient the variable A/I is increased under identical conditions and thus, for example, the time for the flow or the specific flow resistance is reduced.

Preferably, at least one of the polysaccharide-comprising powder having the first particle size A, the polysaccharide-comprising powder having the second particle size B (if included), and the filler having the particle size C (if included) is a water-insoluble material. It is particularly preferred that all of the polysaccharide-comprising powder having the first particle size A, the polysaccharide-comprising powder having the second particle size B (if included) and the filler having the particle size C (if included) are water-insoluble materials. For the purposes of the present invention, water-insoluble material is understood to mean a substance whose solubility in water at 23° C. is less than 0.1 g/ml, preferably less than 0.05 g/ml, and particularly preferably less than 0.01 g/ml. The polysaccharide-comprising powder having the first particle size A and the polysaccharide-comprising powder having the second particle size B (if present) are very particularly preferably coffee powder. Coffee powder in the entire present patent application means powder produced by grinding coffee beans, that is to say no soluble coffee. This ensures that no capsule material dissolves in the water during use of the capsule, that is to say when the water flows through, with the exception of the extractable constituents which are extracted from the capsule material by the water. Because of this, the solids content and thus also the flow resistance of the capsule remains unchanged during the entire extraction process.

According to a first particularly preferred embodiment of the present invention, the powder mixture of the pellet of the capsule contains a polysaccharide-comprising powder having a first average particle size A and ii) a filler having an average particle size C that is identical to the first average particle size A.

By the admixture of an inert mixture partner having the same average particle size as that of the ground coffee, with the same density as for the ground coffee alone, the pellet is increased in volume with the same amount of ground coffee, which means a quadratic increase in the number of capillaries with only a linear increase in capillary length. This reduces the flow resistance of the pellet. If, on the other hand, the volume of the pellet is set as that of a comparable pellet made from ground coffee only, i.e. if the compressing pressure is increased according to the amount of filler added compared to the compressing pressure used for ground coffee alone, the admixture increases the porosity.

In this embodiment of the present invention, it is particularly preferred that the capsule comprises a pellet sheathed with at least one coating layer comprising a crosslinked polysaccharide, which contains a comparatively fine polysaccharide-comprising powder and particularly preferably comparatively fine ground coffee. The average particle size A of the comparatively fine polysaccharide-comprising powder is preferably 0.01 to less than 0.5 mm, more preferably 0.1 to 0.4 mm, particularly preferably 0.2 to 0.4 mm, and very particularly preferably 0.25 to 0.35 mm. Powder having such an average particle size forms pellets having a comparatively low porosity and thus having a comparatively high flow resistance, which are therefore poorly suitable, if at all, for processing in fully automatic coffee machines, since they have a long extraction time for hot water to produce an extract of the polysaccharide and other ingredients from the pellet.

According to the invention, the flow resistance of the pellet in this embodiment is reduced by admixing a filler, preferably an inert filler, having an average particle size C, which is identical to the first average particle size A, by increasing the volume of the molded body by varying the proportion of the inert mixture partner at the same compressing density. If this happens evenly in all three dimensions, the influence of the square-growing number of capillaries over the longer capillary length predominates. This then increases the porosity. As an alternative to this, the flow resistance of the pellet is reduced by admixing the filler by varying the proportion of the inert mixture partner to adjust the pellet of the molded body with the same volume. This causes a change in porosity due to the different capillarity.

As stated above, it is preferred that the polysaccharide-comprising powder having the first particle size A and the filler having the particle size C is in each case water-insoluble.

In order to set a suitable flow resistance, it is proposed in a development of the inventive concept that in this embodiment, the powder mixture of the pellet contains at least 50% by weight of the polysaccharide-comprising powder having the first average particle size A and 1 to 40% by weight of the filler, preferably inert filler, having the identical average particle size C, preferably at least 60% by weight of the polysaccharide-comprising powder having the first average particle size A and 2 to 30% by weight of the filler, preferably inert filler, having the identical average particle size C.

In this embodiment of the present invention, the polysaccharide-comprising powder, that is to say particularly preferably the ground coffee, preferably has a first particle size distribution and the filler has the same particle size distribution.

The overall particle size distribution of the mixture is therefore monomodal. According to the present invention, the particle size distribution is characterized by the diameters d₉₀ and d₁₀, the same particle size distribution meaning that the ratio d₉₀/d₁₀ for the ground coffee is identical to the corresponding ratio for the filler. The particle size d₉₀ means the value of the diameter, which is below 90% of the particles, and the particle size d₁₀ is the value of the diameter, which is below 10% of the particles.

According to a second particularly preferred embodiment of the present invention the powder mixture of the pellet of the capsule contains a polysaccharide-comprising powder having a first average particle size A and ii) a polysaccharide-comprising powder having a second average particle size B different from the first average particle size A, and/or a filler having an average particle size C different from the first average particle size A, wherein the average particle size B and/or the average particle size C is smaller than the first average particle size A.

In this embodiment of the present invention, it is particularly preferred that the capsule comprises a pellet sheathed with at least one coating layer comprising a crosslinked polysaccharide, which contains a powder comprising comparatively coarse polysaccharide and particularly preferably comparatively coarse ground coffee. The average particle size A of the comparatively coarse polysaccharide-comprising powder is preferably 0.5 to 1.5 mm, more preferably 0.7 to 1.3 mm, particularly preferably 0.8 to 1.2 mm, and very particularly preferably 0.9 to 1.1 mm. Powder with such an average particle size forms pellets with a comparatively large porosity and thus with a flow resistance that is too low.

According to the invention, the flow resistance of the pellet in this embodiment is increased by admixing a polysaccharide-comprising powder, particularly preferably ground coffee, having an average particle size B and/or a filler, particularly preferably an inert filler having an average particle size C, which are smaller than the first average particle size A, in that the cavities between the coarse particles having the first average particle size A are at least partially filled by the finer particles with the average particle size B or C, thus reducing the porosity of the pellet.

Good results are obtained in this embodiment in particular if the average particle size B of the polysaccharide-comprising powder is 0.01 to less than 0.5 mm, preferably 0.1 to 0.4 mm, particularly preferably 0.2 to 0.4 mm and is very particularly preferably 0.25 to 0.35 mm.

Likewise, in this embodiment it is preferred that the average particle size C of the filler, preferably inert filler, is 0.01 to less than 0.5 mm, preferably 0.1 to 0.4 mm, particularly preferably 0.2 to 0.4 mm and very particularly preferably 0.25 to 0.35 mm.

As stated above, it is preferred that the polysaccharide-comprising powder having first particle size A, the polysaccharide-comprising powder having the second particle size B (if present) and the filler having the particle size C (if present) are each water-insoluble.

In order to set a suitable flow resistance, it is proposed in a development of the inventive concept that in this embodiment, the powder mixture of the pellet contains at least 50% by weight of the polysaccharide-comprising powder having the first average particle size A and 1 to 40% by weight of the polysaccharide-comprising powder having the second particle size B, and/or a filler, preferably an inert filler, having the average particle size C, preferably contains at least 60% by weight of the polysaccharide-comprising powder having the first average particle size A and 2 to 30% by weight of the polysaccharide-comprising powder having the second average particle size B and/or the filler, preferably inert filler, having the second average particle size C.

In this embodiment of the present invention, the polysaccharide-comprising powder, i.e. particularly preferably the ground coffee, preferably has a first particle size distribution having the first average particle size A, and the polysaccharide-comprising powder having the average particle size B and/or the filler has a different particle size distribution. The overall particle size distribution of the mixture is therefore bimodal. According to the present invention, the particle size distribution is characterized by the diameters d₉₀ and d₁₀, the same particle size distribution meaning that the ratio d₉₀/d₁₀ for the ground coffee is identical to the corresponding ratio for the filler. The particle size d₉₀ means the value of the diameter, which is below 90% of the particles, and the particle size d₁₀ is the value of the diameter, which is below 10% of the particles.

According to a third particularly preferred embodiment of the present invention, the powder mixture of the pellet of the capsule contains a polysaccharide-comprising powder having a first average particle size A and ii) a polysaccharide-comprising powder having a second average particle size B different from the first average particle size A and/or a filler having an average particle size C different from the first average particle size A, wherein the average particle size B and/or the average particle size C is greater than the first average particle size A.

In this embodiment of the present invention, it is particularly preferred that the capsule comprises a pellet sheathed with at least one coating layer comprising a crosslinked polysaccharide, which contains a comparatively fine polysaccharide-comprising powder and particularly preferably comparatively fine ground coffee.

The average particle size A of the comparatively fine polysaccharide-comprising powder is preferably 0.01 to less than 0.5 mm, preferably 0.1 to 0.4 mm, particularly preferably 0.2 to 0.4 mm, and very particularly preferably 0.25 to 0.35 mm. Powder having such an average particle size forms pellets having a comparatively low porosity and thus having a comparatively high flow resistance.

According to the invention, the flow resistance of the pellet in this embodiment is reduced by admixing a polysaccharide-comprising powder, particularly preferably ground coffee, having an average particle size B and/or a filler, particularly preferably an inert filler, having an average particle size C, which are larger than the first average particle sizes A. Without wishing to be bound by any theory in this regard, it is considered within the scope of the present invention that larger continuous capillaries are formed by “getting caught” between the coarser particles, which then enable better flow through. However, there is no so-called “channeling” as with conventional espresso portafilter machines, because here the pellet is held together in the brewing chamber and by means of the sheathing to such an extent that the capillaries cannot expand too far.

Good results are obtained in this embodiment in particular if the average particle size B of the polysaccharide-comprising powder is 0.5 to 1.5 mm, more preferably 0.6 to 1.2 mm, particularly preferably 0.7 to 1.2 mm, and very particularly preferably is 0.8 to 1.2 mm.

Likewise, it is preferred in this embodiment that the average particle size C of the filler, preferably inert filler, is 0.5 to 1.5 mm, more preferably 0.6 to 1.2 mm, particularly preferably 0.7 to 1.2 mm, and very particularly preferably 0.8 to 1.2 mm.

As stated above, it is preferred that the polysaccharide-comprising powder having first particle size A, the polysaccharide-comprising powder having the second particle size B (if present) and the filler having the particle size C (if present) are each water-insoluble.

In order to set a suitable flow resistance, it is proposed in a development of the inventive concept that in this embodiment, the powder mixture of the pellet contains at least 50% by weight of the polysaccharide-comprising powder having the first average particle size A and contains 1 to 40% by weight of the polysaccharide-comprising powder having the second average particle size B, and/or a filler, preferably an inert filler, having the second average particle size C, preferably contains at least 60% by weight of the polysaccharide-comprising powder having the first average particle size A and 2 to 30% by weight of the polysaccharide-comprising powder having the second average particle size B and/or the filler, preferably inert filler, having the second average particle size C.

In this embodiment of the present invention, the polysaccharide-comprising powder, i.e. particularly preferably the ground coffee, preferably has a first particle size distribution having the first average particle size A, and the polysaccharide-comprising powder having the average particle size B and/or the filler has a different particle size distribution. The overall particle size distribution of the mixture is therefore bimodal. According to the present invention, the particle size distribution is characterized by the diameters d₉₀ and d₁₀, the same particle size distribution meaning that the ratio d₉₀/d₁₀ for the ground coffee is identical to the corresponding ratio for the filler. The particle size d₉₀ means the value of the diameter, which is below 90% of the particles, and the particle size d₁₀ is the value of the diameter, which is below 10% of the particles.

According to a fourth particularly preferred embodiment of the present invention, the powder mixture of the pellet of the capsule contains a polysaccharide-comprising powder having a first average particle size A and ii) a filler having an elongated shape with an aspect ratio of greater than 2, preferably greater than 3, particularly preferred greater than 5, and most preferably greater than 10. The aspect ratio here is understood to be the quotient of the longest extension of the filler particle to the shortest extension of the filler particle. Cellulose fibers are preferably used as filler. The admixture of fibrous filler, such as cellulose fibers in particular, increases the porosity because fine capillaries form along the elongated cellulose fibers, which enable better flow through.

In this embodiment of the present invention, it is particularly preferred that the capsule comprises a pellet sheathed with at least one coating layer comprising a crosslinked polysaccharide, which contains a comparatively fine polysaccharide-comprising powder and particularly preferably comparatively fine ground coffee. The average particle size A of the comparatively fine polysaccharide-comprising powder is preferably 0.01 to less than 0.5 mm, preferably 0.1 to 0.4 mm, particularly preferably 0.2 to 0.4 mm, and very particularly preferably 0.25 to 0.35 mm. Powder having such an average particle size forms pellets having a comparatively low porosity and thus having a comparatively high flow resistance.

According to the invention, the flow resistance of the pellet is reduced in this embodiment by the addition of fibrous filler. Without wishing to be bound by any theory in this regard, it is considered within the scope of the present invention that larger continuous capillaries are formed by “getting caught” between the elongated particles, which then enable better flow through. However, there is no so-called “channeling” as with conventional espresso portafilter machines, because here the pellet is held together in the brewing chamber and by means of the sheathing to such an extent that the capillaries cannot expand too far.

In addition, in this embodiment it is preferred that the longest extension of the fibrous filler, preferably inert filler, is 0.5 to 3.0 mm, more preferably 0.6 to 2.4 mm, particularly preferably 0.7 to 2.4 mm, and very particularly preferably 0.8 to 2.4 mm. The shortest extension of the fibrous filler is preferably one third to one eighth of the longest extension.

As stated above, it is preferred that the polysaccharide-comprising powder having the first particle size A and the filler having the particle size C is in each case water-insoluble.

In order to set a suitable flow resistance, it is proposed in a development of the inventive concept that in this embodiment, the powder mixture of the pellet contains at least 50% by weight of the polysaccharide-comprising powder having the first average particle size A and 1 to 40% by weight of the fibrous filler, preferably inert filler, and particularly preferably cellulose fibers, contains preferably at least 60% by weight of the polysaccharide-comprising powder having the first average particle size A and 2 to 30% by weight of the fibrous filler.

The present invention is not particularly limited with regard to the polysaccharide-comprising powder, which is contained in the powder mixture from which the pellet of the capsule according to the invention is composed. Good results are obtained in particular if the powder mixture of the pellet contains a polysaccharide-comprising powder, which is selected from the group consisting of coffee, tea, drinking chocolate, cocoa, and milk powder. Good results are obtained in particular if the powder mixture of the pellet contains ground coffee as a polysaccharide-comprising powder.

According to a particularly preferred embodiment of the present invention, the filler contained in the powder mixture from which the pellet of the capsule according to the invention is composed is an inert filler, i.e. a filler which is an approved food or an approved food additive and is preferably also storage-stable, odorless, and tasteless. With regard to these properties, it has proven to be particularly advantageous if the filler contained in the powder mixture from which the pellet of the capsule according to the invention is composed contains an inert material or preferably consists of an inert material which is particularly preferably selected from the group consisting of silicon dioxide, calcium silicates, cellulose, methyl cellulose, calcium carbonate, titanium dioxide, locust bean gum, aluminum silicates, and any mixtures of two or more of the aforementioned materials.

In the context of the present invention, a pellet is understood to be compacted powder. Good results are obtained in particular if the pellet of the capsule according to the invention can be obtained by pressing a powder mixture, in particular a powder mixture containing ground coffee, at a pressure of 1 to 100 MPa, preferably 5 to 50 MPa, and particularly preferably 15 to 30 MPa. This provides sufficient compression so that the pellet can be sheathed securely and a good oxygen barrier is achieved. At lower pressures there is insufficient cohesion and at higher pressures there is too much compression, which may decompress again after removal from the press, which can destroy the capsules.

In principle, the pellet can have any shape, such as the shape of a truncated cone, cone, ellipsoid, cylinder, cuboid, a coffee bean, or a ball. The capsule according to the invention particularly preferably has the shape of a sphere, since this means that the ratio of surface area to volume is the lowest, as a result of which the flavor is preserved particularly well. In addition, the spherical shape enables the capsule to roll and can therefore be used particularly well in a vending machine.

In order to achieve a stable sheathing of the capsule, it is preferred that the crosslinked polysaccharide of the coating layer has been obtained by crosslinking a polysaccharide with a crosslinking agent with or without the use of a polyol spacer.

Basically, the present invention is not limited with regard to the chemical nature of the polysaccharide of the at least one coating layer. Good results are obtained in particular if the polysaccharide of the at least one coating layer is selected from the group consisting of starch, cellulose, chitin, carrageenan, agar, and alginates. The polysaccharide of the at least one coating layer is particularly preferably a carrageenan or an alginate, it being very particularly preferred that the polysaccharide of the at least one coating layer is an alginate. It has been found in the context of the present invention that these polysaccharides do not cause any distortion of the taste during the preparation of the beverage. In the context of the present invention, it has also been shown that pellets, in particular those made from ground coffee, can be simply and inexpensively sheathed with alginate. Alginates are biodegradable and provide a sufficiently stable sheating and protect the capsule content without any significant loss of flavor. In the context of the present invention, it has also been shown that alginates are able to reduce the water hardness. This mitigates an unpleasant acid taste.

It is substantial to the invention that the polysaccharide of the at least one coating layer is crosslinked. According to one embodiment of the present invention, the polysaccharide can be crosslinked via covalent bonds. Cross-linking via covalent bonds enables very durable sheathing. Crosslinking via covalent bonds usually takes place through the reaction of the polysaccharide with a suitable crosslinking agent. Particularly suitable crosslinkers are difunctional organic compounds, the functional groups being selected, for example, from the group consisting of carboxylic acids, salts of carboxylic acids, activated carboxylic acids, amines, alcohols, aldehydes, and ketones. In this context, activated carboxylic acids are understood to mean carboxylic acid halides, active esters of carboxylic acids, anhydrides of carboxylic acids, or other reactive derivatives of carboxylic acids.

According to an alternative and particularly preferred embodiment of the present invention, the polysaccharide of the at least one coating layer is crosslinked via ionic and/or coordinative bonds. Such polysaccharides crosslinked via ionic and/or coordinative bonds are particularly easy to produce and do not impair the biodegradability of the polysaccharide used. The ionic and/or coordinative crosslinking can be achieved, for example, by means of polysaccharides which have anionic groups, such as carboxylate groups or sulfonate groups. By introducing divalent or higher-value cations, in particular alkaline earth metal ions, an ionic or coordinative crosslinking of the anionic groups of the polysaccharide then takes place in order to form a stable coating layer.

In this context, a coordinative bond denotes an interaction between an electron pair donor and an electron pair acceptor, such as can take place between free electron pairs of oxygen atoms in hydroxyl groups and cations.

The crosslinked polysaccharide is very particularly preferably an alkaline earth metal alginate and most preferably a calcium alginate. In this case, the calcium ions are the crosslinkers because they form coordinative or ionic bonds with groups of the alginate. It has surprisingly been found in the context of the present invention that a sheathing which comprises calcium alginate provides a water-insoluble layer which does not impair the taste of the beverage produced from the capsule and provides sufficient stability of the capsule to ensure transport and touch protection, without the capsule contents suffering any appreciable loss of flavor. Calcium alginate is also extremely biodegradable. Another advantage is that calcium alginate is an approved food additive with E number E405 and is therefore harmless to health. In this embodiment, it is also preferred that the capsule content, that is to say the pellet made of polysaccharide, is at least substantially free of alkaline earth metal ions and in particular calcium ions, which is understood to mean that the pellet, apart from possible alkaline earth metal ions, and in particular calcium ions which are naturally contained in the polysaccharide from which the pellet was produced, contains no further alkaline earth metal ions and in particular calcium ions. In particular, it is preferred that the pellet contained in the capsule or at least 80% of the internal volume of the pellet has an alkaline earth metal ion concentration and in particular calcium ion concentration of less than 1 mol/l, preferably less than 0.1 mol/l, more preferably less than 0.001 mol/l, particularly preferably less than 0.001 mol/l, very particularly preferably less than 0.0001 mol/l and most preferably less than 0.00001 mol/l. 80% of the inner volume of the pellet is understood to mean the volume which is obtained when a spherical surface is stretched from the longest path leading radially from the center to the outer surface of the pellet by the point lying at 80% from the center to the outer surface of the path. Contamination of the pellet with alkaline earth metal ions and in particular calcium ions can be prevented by producing the alkaline earth metal ions and in particular calcium alginate coating by first contacting the pellet with an alkali metal alginate solution and only then contacting a liquid containing alkaline earth metal ions and in particular calcium ions with the formation of the calcium alginate coating, without first contacting with a liquid containing alkaline earth metal and in particular calcium ions before an alkali metal alginate solution is added.

In principle, the capsule according to the invention can only comprise a coating layer made of crosslinked polysaccharide. In order to increase the stability of the capsule and thus the transport security and the touch protection, it is proposed in a development of the inventive concept that the capsule according to the invention comprises two or more coating layers. The pellet of the capsule is preferably sheathed with 2 to 100, particularly preferably with 2 to 20, very particularly preferably with 2 to 10 and most preferably with 2 to 5 coating layers. By sheathing the pellet of the capsule with two or more coating layers, the effect of the coating as an oxygen barrier and the associated provision of effective flavor protection are also achieved to a particularly high degree.

It has been shown that the first coating layer penetrates as a gel into the still rough surface of the pellet and leads to a smoother surface. This means a further reduction in the surface, which further accommodates the flavor tightness. With additional coating layers, an even smoother surface is achieved, which also has the necessary stability, so that even harder impacts remain without damaging effects.

According to a further particularly preferred embodiment of the present invention, the coating of the capsule consists of 2 to 100, preferably 2 to 20, particularly preferably 2 to 10, and most preferably 2 to 5 calcium alginate layers sheathing the pellet.

Depending on the viscosity of the sodium alginate solution and the process used, the individual coating layers have thicknesses between 50 and 600 μm. Layer thicknesses of 100 to 300 μm are particularly preferred for the first coating layer since they have the optimal compromise between stability and drying speed. Subsequent coating layers are preferably thinner and are preferably between 50 and 200 μm in order to enable rapid drying.

A thin coating layer is preferred in order to remove the water contained in the gel more easily and to facilitate diffusion of the crosslinking agent, i.e. the calcium ions, into the sodium alginate as quickly as possible. In principle, the rate of diffusion of the calcium ions into the sodium alginate could also be increased by a higher concentration of the crosslinking agent; however, in the practical implementation of this variant, thin coating thicknesses have proven to be advantageous for the speed of diffusion and handling.

Another object of the present invention is a method for adjusting the flow resistance of a capsule, for preparing a beverage made from beverage powder, in particular coffee made from ground coffee, by introducing water into the capsule, wherein the method comprises the following steps:

i) providing a pellet from a powder mixture which comprises a powder comprising a polysaccharide having a first average particle size A and ii) a) a polysaccharide-comprising powder having a second average particle size B different from the first average particle size A and/or b) a filler having an average particle size C different from the first average particle size A or identical to the first average particle size A, and

ii) sheathing the pellet with a coating layer comprising crosslinked polysaccharide.

The preferred features described above in relation to the capsule according to the invention are also preferred for the method according to the invention.

The present invention further relates to a method for producing a capsule, which comprises the following steps:
i) providing a pellet from a powder mixture which comprises a powder comprising a polysaccharide having a first average particle size A and ii) a) a polysaccharide-comprising powder having a second average particle size B different from the first average particle size A and/or b) a filler having an average particle size C different from the first average particle size A or identical to the first average particle size A,
ii) contacting at least a part and preferably the entire surface of the pellet obtained in step i) with a solution of a polysaccharide in a solvent or with a dispersion of a polysaccharide in a dispersant,
iii) optionally removing the pellet from the solution or the dispersion of step ii),
iv) contacting the pellet obtained in step ii) or iii) with at least one crosslinking agent,
v) if necessary, removing the pellet from the solution of step iv) and
vi) drying the pellet obtained in step iv) or v).

The contacting of the pellet in step ii) is preferably carried out in such a way that at least part of the surface and preferably the entire surface of the pellet is wetted with the solution or the dispersion of the polysaccharide. For example, in steps ii) and iv), the pellet is brought into contact independently of one another by immersing, spraying, or coating the pellet with the solution or the dispersion of the polysaccharide or with the crosslinking agent.

The method according to the invention makes it possible to coat the pellet uniformly, in particular even if the pellet is spherical without creating an edge or a seam.

The solvent or dispersant is preferably a water-based solvent or dispersant. The solvent or dispersant is particularly preferably water.

In step ii), the pellet is preferably immersed in an aqueous 0.5 to 5% by weight alkali metal alginate solution or sprayed with it. In step ii), the pellet is particularly preferably immersed into or sprayed with an aqueous 1 to 2% by weight alkali metal alginate solution. At a concentration of less than 0.5% by weight, the alkali metal alginate solution is not concentrated enough and has a viscosity which is too low to be able to apply a sufficient amount of alkali metal alginate to the pellet by simple immersion or spraying in order to produce a sufficiently stable sheathing in the subsequent steps. If the concentration of the alkali metal alginate exceeds 5% by weight, the viscosity of the alkali metal alginate solution is so high that it is difficult to form a complete sheathing. In addition, the coating thicknesses increase with a concentration of the alkali metal alginate of more than 5% by weight, which makes drying more difficult.

Drying in step vi) can be carried out in different ways, different drying processes having proven successful. A very uniform drying can be achieved, among other things, but not exclusively, by drying in an air stream in suitable channels, the pellet floating freely and drying evenly through its own rotation. In order to be able to better absorb the water diffusing through the coating layer that forms, contact drying on absorbent or warm surfaces has also proven effective. Both principles can be combined in a kind of floating bed channel. Infrared dryers and microwave dryers can also be used as further very efficient drying principles.

Another object of the present invention is the use of the capsule according to the invention for producing a beverage by contacting the capsule according to the invention with water. The capsule preferably contains a material which is selected from the group consisting of coffee, tea, drinking chocolate, cocoa, and milk powder.

The use of the capsule according to the invention for the production of a coffee beverage allows the beverage to be prepared in portions, depending on the need. A particular advantage of the use according to the invention is that only more biodegradable waste is produced.

When the capsule according to the invention is used to prepare a beverage, in particular a coffee beverage, the coffee capsule is preferably crushed or perforated before the crushed or perforated coffee capsule is subsequently extracted with water.

1. A capsule for the preparation of a beverage made from beverage powder by introduction of water into the capsule, wherein the capsule comprises a pellet composed of a powder mixture and the pellet is sheathed with at least one coating layer comprising a crosslinked polysaccharide, wherein the powder mixture of the pellet contains i) a polysaccharide-comprising powder having a first average particle size A and ii) a) a polysaccharide-comprising powder having a second average particle size B different from the first average particle size A, and/or b) a filler having an average particle size C different from the first average particle size A or identical to the first average particle size A.

2. The capsule according to claim 1, wherein the powder mixture of the pellet of the capsule contains a polysaccharide-comprising powder having a first average particle size A and ii) a filler having an average particle size C identical to the first average particle size A.

3. The capsule according to claim 2, wherein the first average particle size A is 0.01 up to less than 0.5 mm.

4. The capsule according to claim 1, wherein the powder mixture of the pellet of the capsule contains a polysaccharide-comprising powder having a first average particle size A and ii) a) a polysaccharide-comprising powder having a second average particle size B different from the first average particle size A and/or b) a filler having an average particle size C different from the first average particle size A, wherein the average particle size B and/or the average particle size C is smaller than the first average particle size A.

5. The capsule according to claim 4, wherein the average particle size A of the polysaccharide-comprising powder is 0.5 up to 1.5 mm.

6. The capsule according to claim 1, wherein the powder mixture of the pellet of the capsule contains a polysaccharide-comprising powder having a first average particle size A and ii) a) a polysaccharide-comprising powder having a second average particle size B different from the first average particle size A and/or b) a filler having an average particle size C different from the first average particle size A, wherein the average particle size B and/or the average particle size C is greater than the first average particle size A.

7. The capsule according to claim 6, wherein the average particle size A of the polysaccharide-comprising powder is 0.01 up to less than 0.5 mm.

8. The capsule according to claim 1, wherein the powder mixture of the pellet of the capsule comprises a polysaccharide-comprising powder having a first average particle size A and ii) a filler having an elongated shape with an aspect ratio of greater than 2.

9. The capsule according to claim 8, wherein the first average particle size A is 0.01 up to less than 0.5 mm.

10. The capsule according to claim 1, wherein the powder mixture of the pellet contains at least 50% by weight of the polysaccharide-comprising powder having the first average particle size A and ii) 1 to 40% by weight of the polysaccharide-comprising powder having the second average particle size B, and/or the filler having the average particle size C, contains at least 60% by weight of the polysaccharide-comprising powder having the first average particle size A and ii) 2 to 30% by weight of the polysaccharide-comprising powder having the second average particle size B, and/or the filler having the average particle size C.

11. The capsule according to claim 1, wherein the polysaccharide-comprising powder contains or preferably consists of a material which is selected from the group consisting of coffee, tea, drinking chocolate, cocoa, milk powder, and any mixtures of two or more of the aforementioned materials.

12. The capsule according to claim 1, wherein the filler contains an inert material, which is selected from the group consisting of silicon dioxide, calcium silicates, cellulose, methyl cellulose, calcium carbonate, titanium dioxide, locust bean gum, aluminum silicates, and any mixtures of two or more of the above materials.

13. A method for adjusting the flow resistance of a capsule by introducing water into the capsule, wherein the method comprises the following steps:
i) providing a pellet from a powder mixture which comprises a powder comprising a polysaccharide having a first average particle size A and ii) a) a polysaccharide-comprising powder having a second average particle size B different from the first average particle size A, and/or b) a filler having an average particle size C different from the first average particle size A or identical to the first average particle size A, and
ii) sheathing the pellet with a coating layer comprising crosslinked polysaccharide.

14. A method for making a capsule according to claim 1, comprising the steps of:
i) providing a pellet from a powder mixture which comprises a powder comprising a polysaccharide having a first average particle size A and ii) a) a polysaccharide-comprising powder having a second average particle size B different from the first average particle size A and/or b) a filler having an average particle size C different from the first average particle size A or identical to the first average particle size A,
ii) contacting at least a part of the surface of the pellet obtained in step i) with a solution of a polysaccharide in a solvent or with a dispersion of a polysaccharide in a dispersant,
iii) removing the pellet from the solution or the dispersion of step ii),
iv) contacting the pellet obtained in step ii) or iii) with at least one crosslinking agent,
v) if necessary, removing the pellet from the solution of step iv) and
vi) drying the pellet obtained in step iv) or v).

15. The method according to claim 14, wherein the pellet is immersed into or sprayed in step ii) with an alkali metal alginate solution, and that the pellet in step iv) is immersed into or sprayed with an alkaline earth metal salt solution.
